(19) United States
(12) Patent Application Publication
(10) Pub. No.: US 2003/0191694 A1
(43) Pub. Date: Oct. 9, 2003

(54) Method and system for authenticating signed memorabilia

(75) Inventors: Rick Vonfeldt, Las Vegas, NV (US); Bryan Miller, N. Las Vegas, NV (US)

Correspondence Address: RUSSELL E. FOWLER, II, ICE MILLER, ONE AMERICAN SQUARE, BOX 82001, INDIANAPOLIS, IN, 46282-0002, US

(73) Assignee: Pro Sports Memorabilia, Inc., Las Vegas, NV

(21) Appl. No.: 10/118,707

(22) Filed: Apr. 9, 2002

(51) Int. Cl. G06F 17/60

(52) U.S. Cl. 705/26

(57) ABSTRACT

The present invention is directed to a method and system for providing authentication services for signed memorabilia. According to the method, a video recording is made when a famous person signs a collectable item. Immediately thereafter, the video recording continues as a tamper resistant sticker is attached to the collectable item. The sticker contains the name of the company hosting the signing, a computer generated encrypted number, and a website address, all of which are viewable on the video recording. The video recording of the signing and placement of the sticker upon the collectable item is stored in a database, and the video recording is associated with the encrypted number in the database. The collectable item is then sold to a purchaser who can view the video recording of the signing of the collectable item through the Internet website.

### BACKGROUND

Many people collect memorabilia objects bearing autographs of famous individuals, such as signed photographs of great sports figures. These objects can be very valuable to collectors. Of course, if the signature on the object turns out to be a forgery, the value of the object is greatly diminished. Thus, forged objects have been and continue to be a great risk to collectors.

Prior art methods have existed for providing authentication services to purchasers of memorabilia. In particular, a number of autograph distributors, including Upper Deck Authenticated, Steiner Sports and Super Star Greetings, provide reputable authentication services to their customers. These authentication services typically include the presence of an autograph distributor representative when the memorabilia object is signed. Immediately after the memorabilia object is signed, the representative places a tamper proof sticker on the memorabilia object. The tamper proof sticker bears the mark of the autograph distributor as well as a hologram revealing a code. The code is typically an alpha-numeric character string. This same code is also found on a paper certificate of authenticity issued by the autograph distributor. The certificate of authenticity not only includes the code, but also describes the memorabilia object. Using this system, if a collector is interested in purchasing a signed memorabilia object, he can look for the tamper proof sticker of the autograph distributor and inquire about its certificate of authenticity. With the sticker attached to the object and the matching certificate of authenticity provided, the collector has some level of assurance that the autograph on the memorabilia object is genuine.

The prior art method for authenticating signatures, as described above, has several shortcomings. In particular, the owner or the memorabila object must be sure to keep track of the certificate of authenticity and be able to provide the certificate if anyone ever questions whether the signature on the memorabilia object is genuine. Of course, if the certificate of authenticity is lost, stolen, or damaged, the value of the memorabilia object may be greatly reduced, as the owner may have difficulty proving that the signature on the memorabilia object is authentic. Thus, it would be advantageous to provide a system and method for authenticating signatures on objects of memorabilia whereby a paper certificate of authenticity is not required for authentication services.

Additionally, although the current prior art method does provide some assurances of authenticity and is somewhat effective in preventing forgeries, it is still possible for dishonest individuals to produce fake stickers and fake certificates of authenticity, thereby deceiving the honest collector. For this reason, purchasers and collectors of the memorabilia objects are always interested in further assurances that signatures on memorabilia objects are genuine. In fact, for many purchasers and collectors, “seeing is believing.” Thus, it would be advantageous to provide a system and method for authenticating signatures where the collectors and/or purchasers of memorabilia objects can actually witness the signing of the memorabilia objects.

Furthermore, the current prior art method of authenticating memorabilia objects does not provide adequate assurances to the purchaser of the memorabilia object that he or she is buying the object from its actual owner. Memorabilia objects are often stolen from the original owner. The thief of the memorabilia object may also steal the certificate of authenticity, making the thief appear to be the actual owner of the memorabilia object. If the thief does not steal the certificate of authenticity, he may attempt to produces a fake certificate of authenticity for the memorabilia object and thereby pass himself off as the true owner of the memorabilia object. Thus, it would be advantageous to provide a system and method for authenticating signatures that provides prospective purchasers with assurances that they are purchasing memorabilia objects from bona fide owners.

For the foregoing reasons there is a need for a system and method for authenticating signatures on objects of memorabilia whereby a paper certificate of authenticity is not required for authentication services. In addition, there is a need for a system that provides authentication services to purchasers and collectors of memorabilia objects wherein the purchasers and collectors may actually witness the signing of the memorabilia object. Furthermore, there is a need for a system that provides prospective purchasers of memorabilia objects with assurances that they are purchasing the objects from bona fide owners.

### SUMMARY

According to the method of the present invention, a video recording is made when a famous person signs a collectable item. Immediately thereafter, the video recording continues as a tamper resistant sticker is attached to the collectable item. The sticker contains the name of the company hosting the signing, a computer generated encrypted number, and a website address, all of which are viewable on the video recording. The video recording of the signing and placement of the sticker upon the collectable item is stored in a database, and the video recording is associated with the encrypted number. The collectable item is then sold to a purchaser (typically a customer at a memorabilia shop).

After purchasing the collectable item, the owner is provided with instructions about viewing the video recording of the signing of the collectable item using a website accessible through the Internet. The owner then uses a customer interface device, such as a personal computer, to visit the website and enters registration information, including the encrypted number, in a designated area of the website. After properly entering all information required for registration of the collectable item, the owner is provided with a registration number and a link to view the video recording associated with the encrypted number. Once the owner indicates that he or she would like to view the video recording, the website downloads the video recording of the signing event and sticker placement from the database to the personal computer and plays the video recording for the owner. The owner can return to the website at any time to view the recording of the signing event by entering the registration number and choosing an option to view the signing.

Furthermore, those interested in buying the collectable item from the owner may also view the signing event through the website if the owner provides them with the encrypted number. After viewing the signing event, the prospective purchasers are provided with an e-mail link back to the owner of the collectable item so an offer may be made on the collectable item.

Accordingly, the present invention satisfies the need for authentication services that do not require a paper certificate. In addition, the present invention provides authentication services whereby purchasers and collectors can view a video recording of the signing of the memorabilia object and thereby witness the signing event. Furthermore, the present invention provides prospective purchasers of memorabilia objects with assurances that they are purchasing the objects from bona fide owners. These and other features, aspects, and advantages of the present invention will become better understood with reference to the following description and appended claims.

### BRIEF DESCRIPTION OF THE DRAWINGS

FIG. 1 shows the connection between components in a system for authenticating signed memorabilia;

FIG. 2 shows a block diagram of the method for authenticating signed memorabilia;

FIG. 3 shows a first web page demonstrating a signing event according to the method of FIG. 2;

FIG. 4 shows a second web page describing the video recording taken according to the method of FIG. 2;

FIG. 5 shows a third web page demonstrating application of the identifying indicia to the memorabilia object according to the method of FIG. 2;

FIG. 6 shows a fourth web page describing the registration process used in the method of FIG. 2;

FIG. 7 shows a fifth web page demonstrating the ability to view the video recording according to the method of FIG. 2;

FIG. 8 shows an exemplary view of the information provided when a video recording is shown according to the method of FIG. 2.

### DESCRIPTION

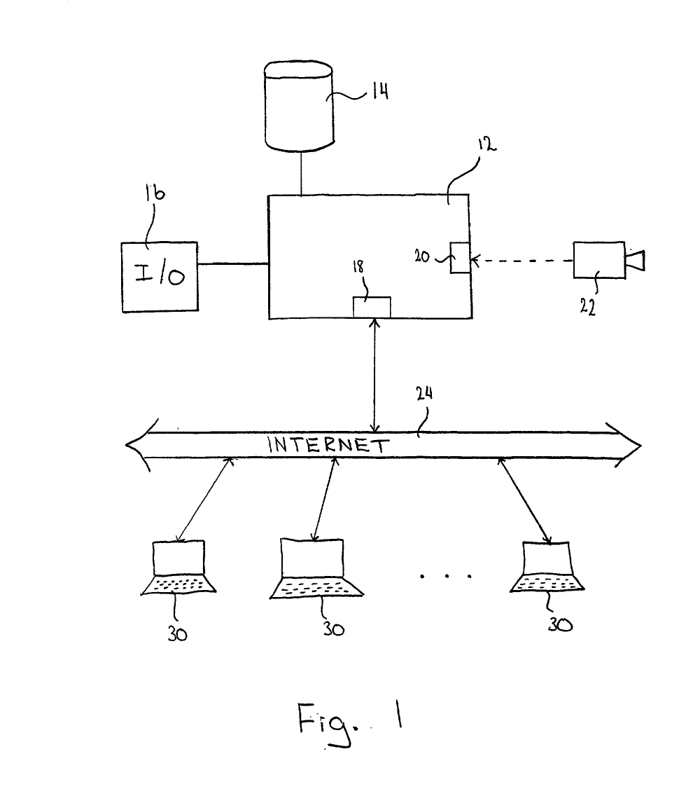

With reference to FIG. 1, a method and system for authenticating signed memorabilia utilizes a central computer 12, including an internal memory and a CPU. The central computer 12 is connected to a database management system 14, or simply “database.” The database 14 may reside on a mass storage device such as a disk drive, tape drive or other electronic storage media such as optical disks. The database is operable to store files and associate information with each file stored in the database. Input/output devices 16 are also connected to the computer. The input/output devices 16 include a monitor, speakers, mouse, keyboard, printer and/or other devices that allow a user to receive information from the computer 12 or provide information to the computer.

The central computer 12 further includes a communications interface 18 providing a connection between the central computer 12 and a wide area network 24, such as the Internet. The communications interface 18 may be a modem connection to telephone lines, a cable modem, or other device for connecting the central computer to the wide area network. A plurality of remote computers 30 are connected to the central computer 12 through the wide area network 24. The wide area network 24 provides a platform for allowing information to flow back and forth between the central computer 12 and the plurality of remote computers 30.

A video recorder 22 is provided in association with the central computer. The video recorder is operable to capture video images and may be either an analog or digital device. A data transfer interface 20 is provided for transfering video images on the video recorder to the computer for subsequent storage in the database. The dashed line in FIG. 1 indicates that data from the video recorder 22 is delivered to the computer through the data transfer interface 20. The data transfer interface 20 may be any of a number of standard devices used to deliver data to a computer. For example, the data transfer interface 20 may be a USB port providing a direct connection to the video recorder 22 or a disk drive for receiving a disc containing data captured by the video recorder. Also, the data transfer interface 20 may be embodied by the communications interface 18 if the data of the video recording is transferred to the central computer 12 from a remote location using the Internet.

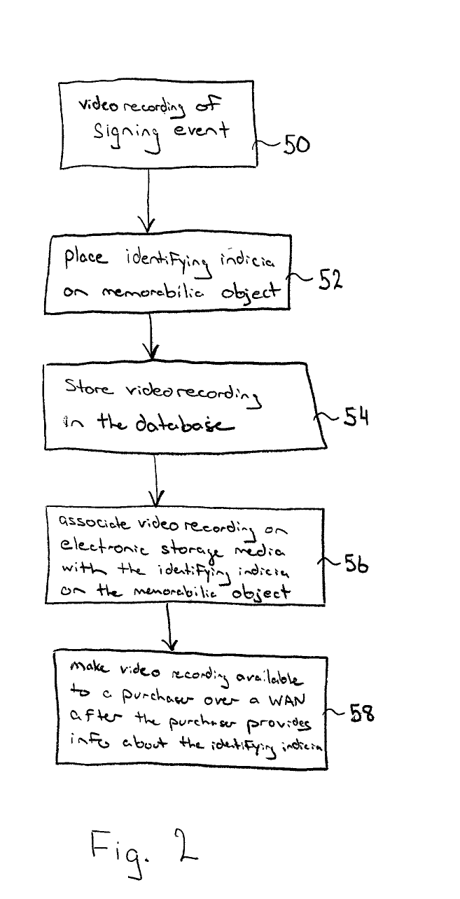

With reference to FIG. 2, the method of the invention first involves the step 50 of making a video recording of a signing event using the video recorder 22. A signing event occurs when an individual autographs an object of memorabilia. As used herein, the terms “objects of memorabilia,” “items of memorabilia,” “memorabilia objects” or “memorabilia” include those items that hold some value to certain individuals because the items are associated with some individual, organization, location or event, such as a famous person, team, city or sporting event. Examples of items of memorabilia include the following: a Chicago Bears football helmet, a photograph of Wayne Gretzky, a New York Yankees baseball cap, a Los Angeles Lakers basketball jersey, a U.S. Open T-shirt, and a baseball hit by Barry Bonds. Of course, some objects of memorabilia, such as the photograph of Wayne Gretzky are associated with a famous individual before the autograph is placed on the object. Other items of memorabilia, such as the U.S. Open T-shirt, are not associated with any particular individual until they are signed by a famous figure. In the case of the U.S. Open T-shirt, Tiger Woods' autograph greatly increases the value of the T-shirt.

For authentication purposes, the signing event typically takes place in a controlled environment where the famous person is asked to come to a particular location and sign a number of different objects of memorabilia during one sitting. A reputable autograph distributor such as Upper Deck Authenticated, Steiner Sports, or Super Star Greetings will typically conduct the signing event. The presence of one of these reputable autograph distributors will provide additional assurances to purchasers of the autographed items that the signatures are authentic. Of course, a signing event may also occur in a less controlled environment, such as immediately following a game where the sports figure signs a memorabilia object. These less formal signing situations should also include the presence of a reputable autograph distributor as well as a video recording of the signing event.

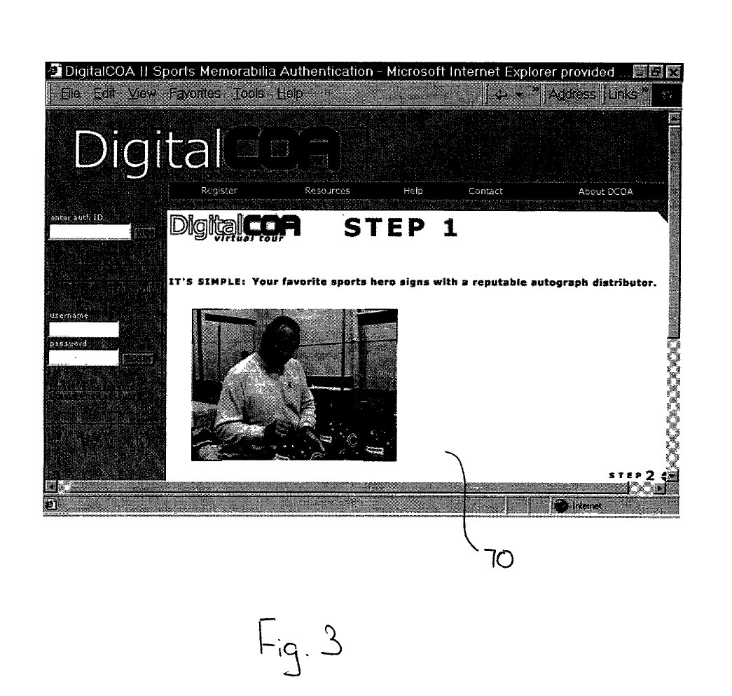

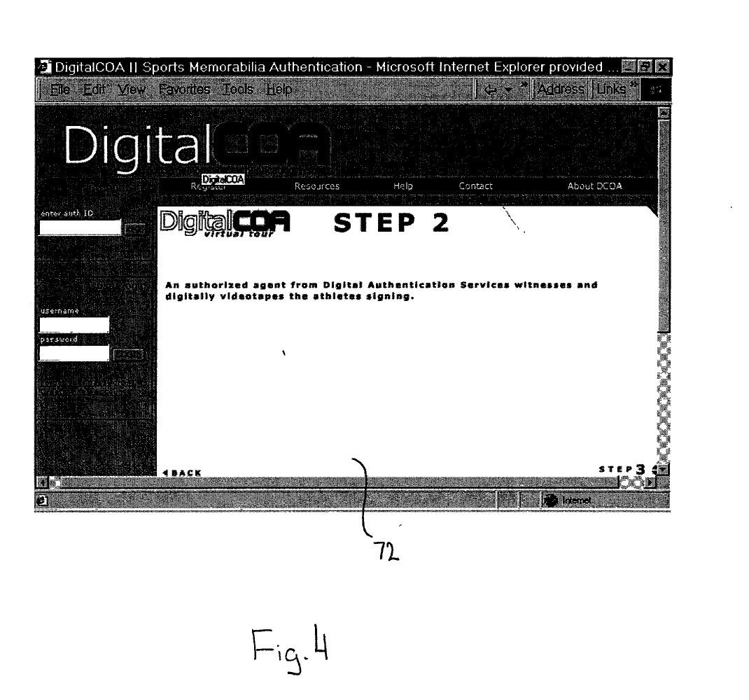

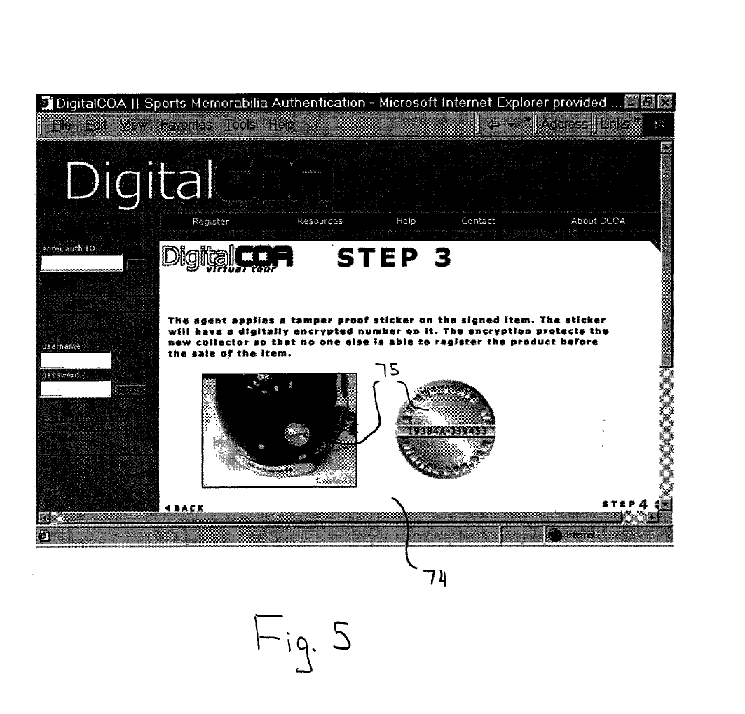

During the signing event, a video recording is made of the famous person signing the object of memorabilia. The video recording is preferably a digital video recording made with a digital video camera. This allows the digital recording to be quickly and easily transferred to the database using the data transfer interface. However, the video recording may also be a video tape taken with an analog video taping device or any other video capture method and associated device. When the video recording is an analog video tape, the video tape must copied in digital format so it can be stored on the computer database. Two web pages 70 and 72 demonstrating and explaining this first step 50 of the authentication process are shown in FIGS. 3 and 4. Such web pages are placed a system website and used in describing the authentication method to customers and potential customers. As shown in FIGS. 3 and 4, a video recording of Dick Butkus is made as he signs a Chicago Bears football helmet in the presence of a reputable autograph distributor. FIGS. 5-7 also show web pages 74, 76 and 78 demonstrating and explaining subsequent steps of the authentication process.

As indicated by reference numeral 52 in FIG. 2, the next step of the method of authentication involves placing identifying indicia on the signed memorabilia object immediately after the memorabilia object is signed by the famous individual. The identifying indicia includes a code in the form of a digitally encrypted number or alpha-numeric string. In the preferred embodiment of the invention, the identifying indicia takes the form of a tamper proof sticker and the digitally encrypted number is included on the tamper proof sticker. The tamper proof sticker strongly adheres to the object of memorabilia such that it is very difficult to remove it from the object without destroying the tamper proof sticker. An exemplary tamper proof sticker 75 is shown in FIG. 5, which shows a web page 74 describing the step of placing the identifying indicia on the memorabilia object. The tamper proof sticker 75 includes a hologram that reveals the code. This hologram not only makes the code difficult to see from a distance, but also makes the tamper proof sticker difficult to duplicate. The code on the identifying indicia is also referred to herein as the “Authentication Identification Number” or “AuthID.” In an alternative embodiment of the invention, alternative means may be used for placing identifying indicia on the object of memorabilia. For example, a stamp, seal, or other similar marking means may be used to provide the identifying indicia on the object of memorabilia. The tamper proof sticker also provides a web address where the purchaser may authenticate the object of memorabilia using the digitally encrypted number placed on the sticker. For example, the wording around the circumference of the tamper proof sticker in FIG. 5 reads “AUTHENTICATE AT: DIGITALCOA.COM”.

With reference again to FIG. 2, the next step of the method, identified by reference numeral 54, is to store the video recording of the signing event in the database. As discussed above, when the video recording was made with a digital camera the video recording of the signing event can be transferred to the central computer 12 by simply transferring the recording stored on the digital camera to the memory of the central computer. Once the central computer receives the video recording, the user may identify a filename for the video recording using the I/O device 16, and the video recording will be stored in the database. If the video recording was not made using a digital camera, the video recording must be copied to digital format before it is stored in the database.

Reference numeral 56 of FIG. 2 identifies the next step of the method of authenticating signed memorabilia. Once the video recording is stored in digital format in the database, it is associated in the database with the identifying indicia that was placed on the object of memorabilia recorded on the video recording. In particular, the memorabilia object is associated in the database with the code on the tamper proof sticker. For example, as shown in FIG. 5, a Chicago Bears football helmet has been signed by Dick Butkus and a tamper resistant sticker with the digitally encrypted number “19384A-J39453” is placed on the helmet. When the video recording of this signing event is stored in the database, it is associated with the Authentication Identification Number “19384A-J39453.” Thus, the video recording of Dick Butkus signing the football helmet may be located in the central computer by searching the database for the AuthID “19384A-J39453.”

Once the video recording is stored in the database and associated with the Authentication Identification Number, it is available for viewing by the purchaser of the object of memorabilia shown in the video recording. Before viewing the recording, the purchaser of the object of memorabilia is asked to log on to a system website provided through the central computer (or other computer connected to the wide area network) and register with the website. The URL address for this system website is preferably located on the tamper proof sticker attached to the signed memorabilia object. When registering with the system website, the owner of the memorabilia object enters personal information such as name, address, e-mail, phone number, desired username and password. After completing the registration process, the registrant is authorized to use certain features of the system. For example, the registrant is provided with a personalized home page that is presented to the registrant when he or she logs on to the system. The personalized home page provides the registrant with a link that allows the registrant to associate himself or herself with an object of memorabilia already in the database. The registrant is typically required to pay a fee to make this association. As explained in more detail below, the association between a registrant and a memorabilia object provides the registrant with certain advantages in using the system.

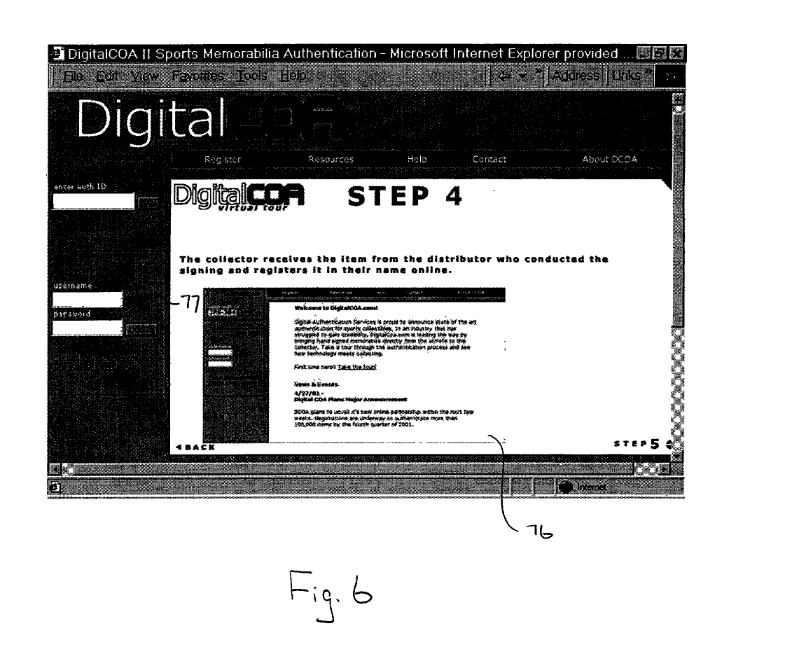

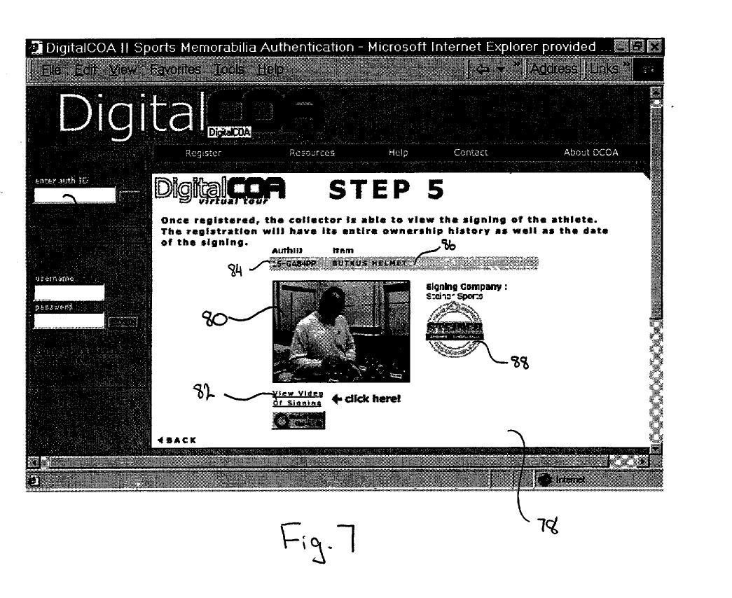

After accessing the system, registrants can log on to the system using the user login location 77, as shown in FIG. 6, provided at the left of the system web pages. After the registrant enters his username and password, the registrant's personalized home page is displayed. The registrant's personalized home page provides the registrant with a list of memorabilia objects associated with the registrant in the system database. These memorabilia objects are owned by the registrant and authenticated through the system, and others are prevented from registering as the owner of the same memorabilia objects. If the registrant wishes to find out more information about one of the memorabilia objects in the list, he or she simply clicks on the object in the list. After clicking on the object in the list, an image of the signing event appears, as shown in FIG. 7. A link 82 to view a video recording of the signing event is provided under the image of the signing event. By clicking on the link 82 to view the video recording of the signing event, the complete recording of the signing event will be shown in place of the existing still image. When the registrant views the image or recording, other information is provided on the same page, including the AuthID 84, a written description of the object of memorabilia 86, the emblem 88 of the autograph distributor that conducted the signing event (e.g., Upper Deck, Steiner Sports, etc.). Of course, other information about the object of memorabilia may also be included with the image, such as a brief history of authentication of the object of memorabilia and past owners.

The registrant's personalized home page also provides the registrant with a user preferences link (not shown). The user preferences link allows the registrant to manage various aspects of his or her account, including user password, address of record, and other personal information. In addition, the user preferences link allows the user to choose whether to display his or her e-mail when the video recording of the signing event for a memorabilia object owned by the registrant is viewed by other users. The display of the registrant's e-mail allows others interested in the memorabilia object to contact the registrant/owner when viewing the video recording of the signing event if they are interested in purchasing the memorabilia object. As explained below, with this option in place, interested purchasers can contact the owner of the memorabilia object by simply clicking on the registrant's e-mail displayed next to the video recording. After clicking on the e-mail link, an e-mail message is created addressed to the owner of the memorabilia object. The interested purchaser may then complete the e-mail message with the terms of the offer to the owner and the interested purchaser's return address.

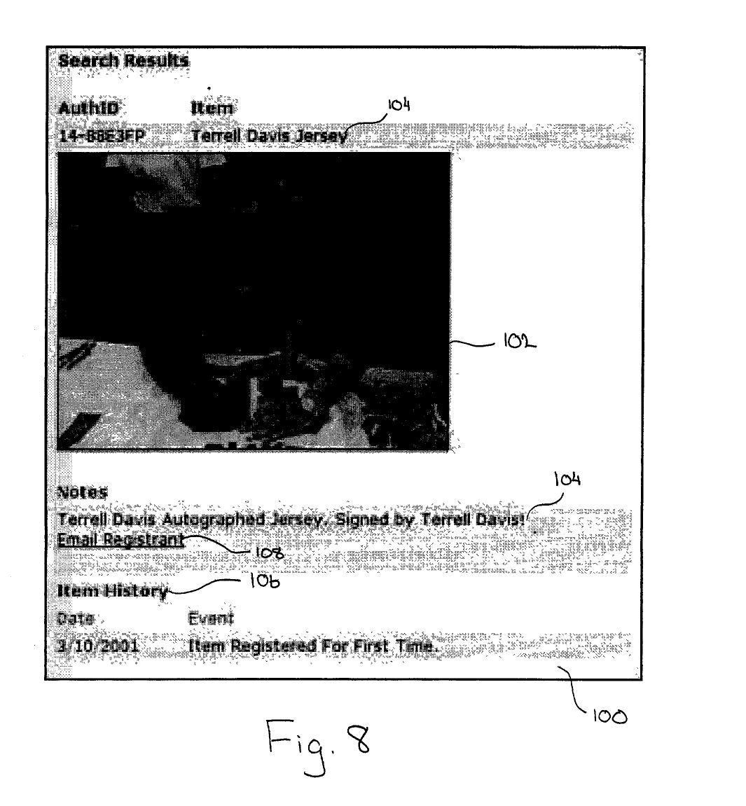

The system thus provides a tool for helping system registrants sell objects of memorabilia. In particular, if one person is interested in purchasing an object from a registrant, the registrant can provide the authentication code to the interested party. The interested party then visits the system website and enters the AuthID in the information entry location 90, which, as shown in FIG. 7, is a box to the left of each system web page having a space provided for entry of AuthIDs. With reference to FIG. 8, after entering a valid AuthID, a page 100 is displayed to the interested party showing a picture 102 of the signing event associated with the AuthID. In this case, FIG. 8 shows a picture of a signing event where Terrell Davis is autographing a jersey. This page 100 also provides a written description of the item 104, the ownership history of the item on the website 106, the emblem of the autograph distributor (not shown) and, if the registrant/owner has designated a link under his or her user preferences, a link 108 allowing the interested party to e-mail the registrant who owns the item. After viewing information about the item of memorabilia and related signing event on the web page 100, the interested party may wish to make an offer to purchase the item. If this is the case, the interested party selects the e-mail link 108, and an e-mail message to the owner of the memorabilia object is automatically created. The interested party then completes the e-mail message by entering a return e-mail address along with an offer for the memorabilia object and any additional comments. The e-mail message is then sent to the owner, and the interested party waits for an e-mail response from the owner accepting or rejecting of the offer. This operation provides a prospective purchaser with some level of assurance that he is communicating with the bona fide owner of the memorabilia object. Specifically, if the apparent owner of the memorabilia object does not receive the e-mail message from the prospective purchaser, the prospective purchaser will know that a serious risk exists that the apparent owner is not a bona fide owner. In addition, because the item he or she is interested in is registered with the system, the prospective purchaser can be assured that the memorabilia object he is interested in is actually authentic.

Although the present invention has been described in considerable detail with reference to certain preferred versions thereof, other versions are possible. For example, the invention is not limited to those situations where an actual autograph is placed on the memorabilia object. In particular, the term “signing event” as used herein could include any number of other situations where an important person places a mark on an object or otherwise becomes associated with a particular object. Likewise, the term “signature” or “autograph” as used herein could include a number of other actions where an important person places a mark on an object or otherwise becomes associated with a particular object other than through signing a name on an object. Examples of these “signing events”, “signatures” or “autographs” may include, but are not limited to, placement of a handprint, fingerprint or lipstick kiss on an object, or association with particular garments by an individual wearing those garments at special events. In addition, system and related method may include additional features not discussed above. For example, in an alternative embodiment, the system website may provide additional information and special events for collectors and prospective purchasers, such as live webcast signings and informational articles on sports memorabilia authentication, collection, and other relevant links. As another example, when a prospective purchaser views information about an object of memorabilia and the related signing event through the system website, the prospective purchaser may be given the option to view the complete video of the signing event. Of course, the above examples are but a few of the variations of the system and method of the present invention. Therefore, the spirit and scope of the appended claims should not be limited to the description of the preferred versions contained herein.

What is claimed is:

1. A method of providing authentication services to a purchaser of a memorabilia object autographed by an individual at a signing event, the method comprising the steps of:
a. making a video recording of the individual and memorabilia object during the signing event;
b. placing identifying indicia on the memorabilia object;
c. storing the video recording on electronic storage media connected to a wide area network;
d. associating the video recording stored on electronic storage media with the identifying indicia;
e. receiving information about the identifying indicia from a remote computer connected to the wide area network; and
f. making the video recording available for viewing at the remote computer following receipt of the information about the identifying indicia.

2. The method of claim 1 wherein the step of placing identifying indicia on the memorabilia object is shown on the video recording.

3. The method of claim 1 where the identifying indicia is a tamper proof sticker.

4. The method of claim 1 wherein the information about the identifying indicia is a code included on the identifying indicia.

5. The method of claim 1 wherein the step of making the video recording available for viewing includes providing a first web page accessible through the remote computer, and providing an e-mail link to the owner of the memorabilia object that is accessible on the first web page or an associated web page.

6. The method of claim 1 further comprising the step of providing a certificate to the purchaser of the memorabilia object, the certificate including a description of the memorabilia object and information about the identifying indicia.

7. A system for providing authentication services to a purchaser of a memorabilia object autographed by an individual at a signing event, the system for providing authentication services comprising:
a. means for recording the individual and memorabilia object during the signing event;
b. identifying indicia for placement on the memorabilia object after the individual signs the memorabilia object;
c. means for electronically storing the recording, the means for storing the recording connected to a wide area network;
d. means for associating the electronically stored recording with the identifying indicia;
e. means for receiving information about the identifying indicia from a remote computer connected to the wide area network; and
f. means for making the video recording available for viewing at the remote computer following receipt of the information about the identifying indicia.

8. The system of claim 7 wherein the recording taken with the means for recording shows the placement identifying indicia on the memorabilia object as well as the individual and memorabilia object during the signing event also includes is shown on the video recording.

9. The system of claim 7 where the identifying indicia is a tamper proof sticker.

10. The system of claim 7 wherein the information about the identifying indicia is a code included on the identifying indicia.

11. The system of claim 7 wherein the means for making the video recording available for viewing at the remote computer includes a first web page accessible through the remote computer and an e-mail link to the owner of the memorabilia object that is accessible on the first web page or an associated web page.

12. A method of authenticating a signature on one of a plurality of memorabilia objects, the method comprising the steps of:
a. video recording the signature as it is placed on the memorabilia object;
b. marking the memorabilia object with a code;
c. storing the video recording in a database and associating the video recording with the code in the database;
d. playing the video recording on a computer after the code is entered into the computer.

13. The method of claim 12 further comprising the step of video recording the marking of the memorabilia object with the code.

14. The method of claim 12 wherein the step of marking the memorabilia object with a code includes placing a tamper resistant sticker on the memorabilia object.

15. The method of claim 12 wherein the step of playing the video recording on a computer after the code is entered in the computer is provided by making the video recording available for viewing through a first web page.

16. The method of claim 15 wherein the first web page also provides an e-mail link to the owner of the memorabilia object.

17. The method of claim 12 further comprising the step of providing a certificate to a purchaser of the memorabilia object, the certificate including a description of the memorabilia object and the code.

18. A memorabilia authentication system connected to a plurality of remote computers over a wide area network, the memorabilia authentication system providing authentication services related to a plurality of memorabilia objects autographed by at least one individual at a plurality of signing events, each of the plurality of signing events followed by placement of one of a plurality of codes on one of the plurality of memorabilia objects, the memorabilia authentication system comprising:
a. electronic storage media having a plurality of video recordings stored thereon, each of the video recordings showing one of the plurality of signing events;
b. a database associating each of the video recordings with one of the plurality of codes;
c. a central computer connected to the database, the electronic storage media and the wide area network, the central computer providing
(i) an information entry location accessible at one of the plurality of remote computers for allowing entry of one of the plurality of codes; and
(ii) a viewing location accessible at one of the plurality of remote computers for playing the video recording associated with the one of the plurality of codes entered at the information entry location.

19. The system of claim 18 wherein the code is an alpha-numeric character string.

20. The system of claim 18 wherein the code is located on a tamper resistant sticker.
